(19) United States
(12) Patent Application Publication
(10) Pub. No.: US 2009/0276261 A1
(43) Pub. Date: Nov. 5, 2009

(54) ASSESSMENT METHOD FOR PROCESS IMPROVEMENT DECISIONS

(75) Inventor: SHIH-LUNG CHEN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY (TW)

(21) Appl. No.: 12/164,534

(22) Filed: Jun. 30, 2008

(30) Foreign Application Priority Data
May 5, 2008 (TW) 97116423

(51) Int. Cl. G06Q 10/00

(52) U.S. Cl. 705/7

(57) ABSTRACT

A risk assessment method for process improvement decisions applying for semiconductor process change comprises: performing a risk assessment evaluation to compute a polarity (plurality?) of items corresponding to their values, generating a risk assessment evaluation value to determine if the risk assessment evaluation value is in a risk setting value, go to next two steps; not, go to next step; performing an active inspect for the polarity (plurality?) of items corresponding to their item setting values, if not satisfied with the active inspect, repeat the above step; if not, transferring the semiconductor process change to online process.

### BACKGROUND OF THE INVENTION

1. Field of the Invention

The present invention generally relates to an assessment method for process improvement decisions; in particular, it relates to an assessment method for process improvement decisions in the field of semiconductor process change application.

2. Description of Related Art

In current semiconductor foundries for integrated circuit manufacture, it has become one of the most essential key points for present semiconductor foundries to find applicable approaches for full exploitation on the performance of production facility management, advancement in high reliability for process equipment improvement, reduction of influence brought on by process failure risks, in order to control and lessen the damage induced by occurrence of such failures, which are also the most effective paths to increase product yield rate as well as to enhance the competitiveness of semiconductor foundries in semiconductor fabrication.

The prior art Failure Mode and Effects Analysis (FMEA) disclosed a method. Refer now to FIG. 1, which uses a standard table and trouble-shooting method to identify potential failure modes and influences thereof, wherein, addressed to the process equipments with high failure risk influence inside the semiconductor fabrication factories, based on systematic management, it assesses a corresponding Severity (S) 102, an Occurrence (O) 104 and a Detection (D) 106 to analyze and accumulate engineering knowledge and experience, so as to compute a Risk Priority Number (RPN) 108, which can be expressed by the following equation:

RPN=S×O×D

wherein RPN represents the Risk Priority Number 108, S the Severity 102, O the Occurrence 104 and D the Detection 106; when the RPN 108 exceeds 100, it provides practical and feasible improving methods, with an attempt to build up the risk management for the semiconductor production equipments and to ameliorate the mechanism for reliability improvement, with an effort to offer the feature of precaution.

However, when using the prior art Failure Mode and Effects Analysis in the semiconductor processes, since the Occurrence 104 (O) and the Detection 106 (D) may not be acquired in advance before the change of semiconductor process, which accordingly requires users' predictions or even conjectures based on their accumulated experience in the past, it is not possible, as a result, to provide a reliable, precise risk assessment and valid trouble-shooting solutions for semiconductor process change.

Accordingly, the inventors of the present application having considered the above-mentioned improvable limitations and disadvantages, and also based on their experiences in relevant fields in conjunction with thorough observations and researches, along with use of academic theory, have thus proposed the present invention of reasonable design which can effectively resolve the aforesaid limitations and problems.

### SUMMARY OF THE INVENTION

Therefore, the objective of the present invention is to provide an assessment method for process improvement decisions, which offers assessment evaluation and process improvement decision regarding to semiconductor process change, so as to reduce learning cycle of semiconductor process change, and also lessen process change cost and risk, thus increasing process efficiency and yield rate.

According to the above-mentioned objective, the present invention proposes an assessment method for process improvement decisions which is applicable to a semiconductor process change, comprising the following steps: performing a risk assessment evaluation computation for a plurality of items each with a corresponding value, wherein the product of the corresponding value is for generating a risk assessment evaluation value to compare and determine whether the risk assessment evaluation value has exceeded a predetermined risk value or not, if not then go to the final step of transferring the semiconductor process change to assembly line process; if yes, then performing an active inspection for the corresponding values of the plurality of items against their respective predetermined item setting values, in order to determine if the predetermined item setting values has been exceeded or not; next, if the predetermined item setting values has been exceeded (i.e. not satisfied with the active inspection), repeat the above step of risk assessment evaluation value comparison; otherwise, if the predetermined item setting values has not been exceeded (i.e. satisfied with the active inspection), go to the final step of transferring the semiconductor process change to assembly line process. Herein the said plurality of items consist of at least an EXPERIENCE, an INFLUENCE AREA and an AGGRESSIVE CHECK POINT, wherein the EXPERIENCE provides a corresponding confidence value, the INFLUENCE AREA provides a coverage value and the AGGRESSIVE CHECK POINT provides a criteria value, and the product of the confidence value, the coverage value and the criteria value acts as the risk assessment evaluation value.

The present invention presents the following beneficial effects:

1. The risk assessment evaluation value enables risk assessment and decision for process improvement, facilitating creation of risk management of semiconductor process equipments and enhancement of mechanism for reliability improvement;

2. The EXPERIENCE provides determination of confidence value, which effectively accumulates past experiences, increasing process efficiency of semiconductor process change;

3. the INFLUENCE AREA provides determination of coverage value, which effectively evaluates the range of influence caused by failure, and reduces the coverage of possible failure, achieving the possibility for determining risk assessment and process improvement decision in the course of semiconductor process change;

4. The AGGRESSIVE CHECK POINT provides determination of criteria value, which offers the feature of precision for determining risk assessment and process improvement decision in the course of semiconductor process change.

In order to provide more thorough and complete descriptions of the present invention, in the subsequent illustrations there provide several embodiments or examples which, in conjunction with the appended drawings, can be used to fully appreciate and understand the applications of different characteristics in various embodiments.

### BRIEF DESCRIPTION OF THE DRAWINGS

FIG. 1 is a table diagram for prior art risk assessment.

FIG. 2 is a flowchart of the method according to the present invention.

FIG. 3A is a table diagram (1) of an embodiment according to the present invention.

FIG. 3B is a table diagram (2) of an embodiment according to the present invention.

FIG. 3C is a table diagram (3) of an embodiment according to the present invention.

FIG. 3D is a table diagram (4) of an embodiment according to the present invention.

FIG. 4 is a table diagram (5) of an embodiment according to the present invention.

FIG. 5 is a risk assessment report diagram (1) of an embodiment according to the present invention.

FIG. 6 is a risk assessment report diagram (2) of an embodiment according to the present invention.

FIG. 7 shows a learning curve diagram comparing an embodiment according to the present invention with the prior art.

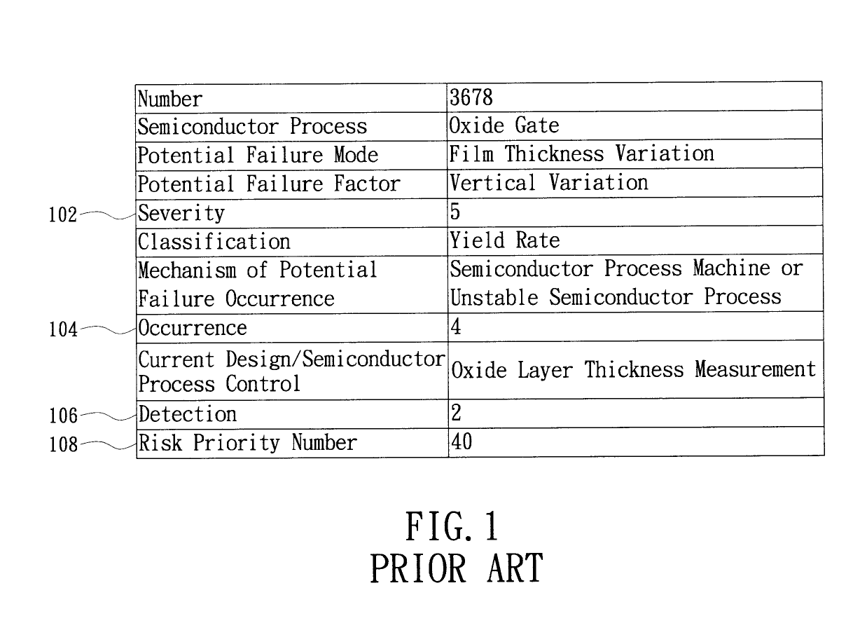

### DETAILED DESCRIPTION OF THE PREFERRED EMBODIMENTS

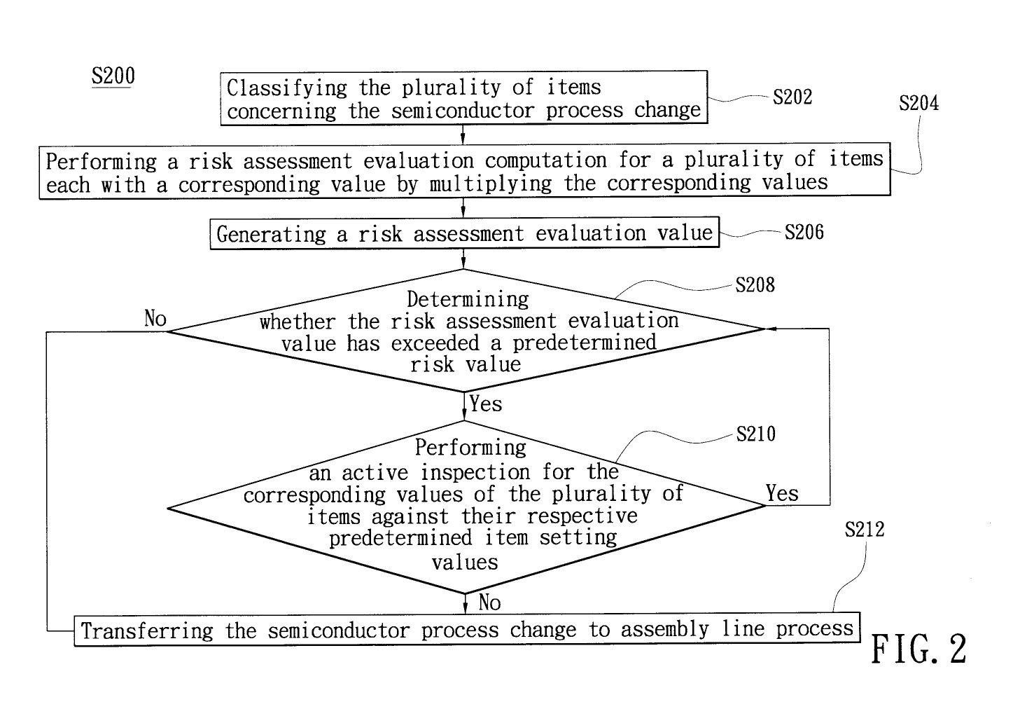

Refer now to FIG. 2, wherein the present invention provides an assessment method S200 for process improvement decisions which is applicable to a semiconductor process change, comprising the following steps: step S202, step S204, step S206, step S208, step S210 and step S212.

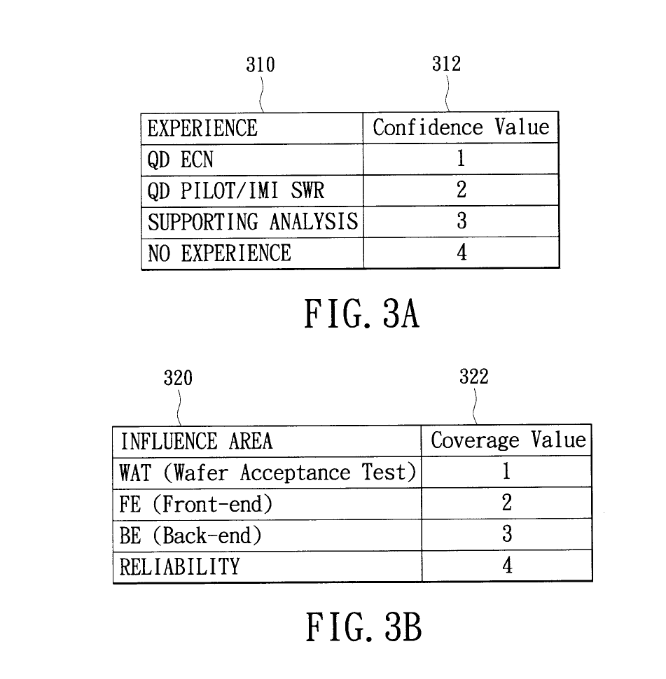

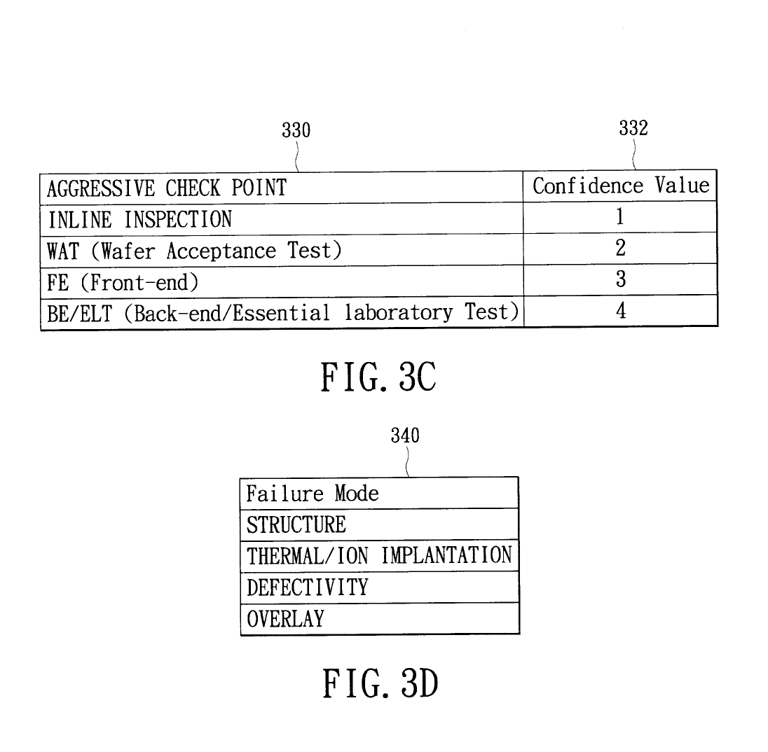

The execution of the step S202 consists of classifying the plurality of items concerning the semiconductor process change, in which, with reference to FIGS. 3A to 3D, these items include an EXPERIENCE 310, an INFLUENCE AREA 320 and an AGGRESSIVE CHECK POINT 330. The value to which the EXPERIENCE 310 corresponds is a confidence value 312, in which the EXPERIENCE 310 includes QD ECN (Quality Design with Engineering Change Note: there exist other factories of the same category), QD PILOT/IMI SWR (Quality Design PILOT/Incoming Material Inspection of Semiconductor Wafer Representation: batch experiment in median/small quantity during experiment), SUPPORTING ANALYSIS or NO EXPERIENCE, and the confidence value 312 for each respectively corresponding item is sequentially 1, 2, 3 and 4. The corresponding value for the INFLUENCE AREA 320 is a coverage value 322, wherein the INFLUENCE AREA 320 contains WAT (Wafer Acceptance Test: electronic analysis), FE (front-end), BE (back-end) or RELIABILITY, and the coverage value 322 for each respectively corresponding item is sequentially 1, 2, 3 and 4. The value to which the AGGRESSIVE CHECK POINT 330 corresponds is a criteria value 332, wherein the AGGRESSIVE CHECK POINT 330 consists of INLINE INSPECTION (assembly line check), WAT (Wafer Acceptance Test: electronic analysis), FE (front-end) or BE/ELT (back-end/essential laboratory test: client side), and the criteria value 332 for each respectively corresponding item is sequentially 1, 2, 3 and 4. Additionally, in the present embodiment, the said plurality of items further comprise a Failure Mode 340, wherein the Failure Mode 340 includes STRUCTURE, THERMAL/ION IMPLANTATION, DEFECTIVITY or OVERLAY, for users' references without corresponding value.

The execution of step S204 consists of a risk assessment evaluation, which calculates the product of the corresponding values of the plurality of items concerning the semiconductor process change (i.e. by multiplying the corresponding values).

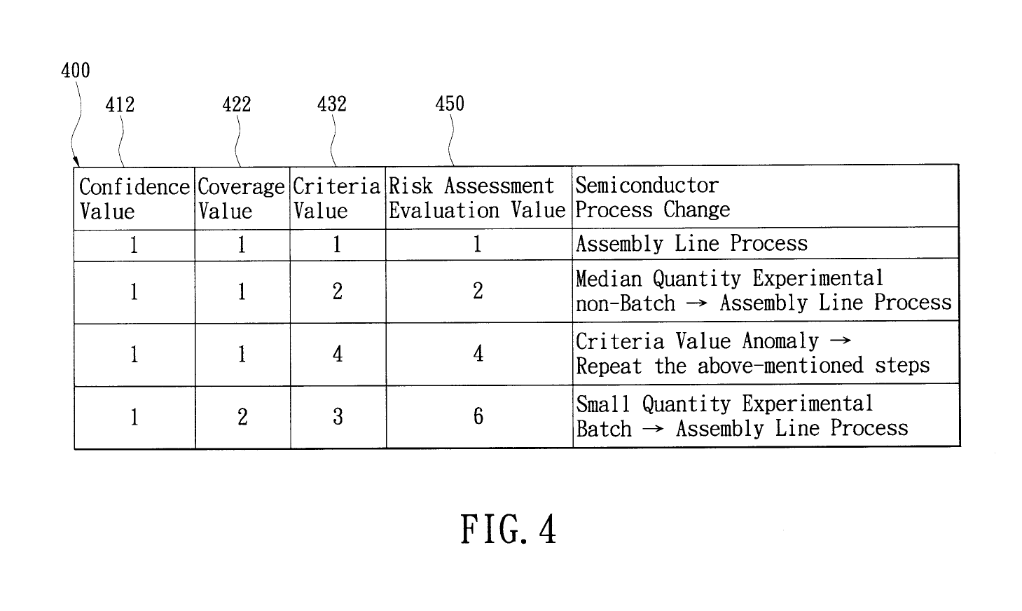

The execution of step S206, referring to FIG. 4, by means of multiplication of the confidence value 412, the coverage value 422 and the criteria value 432 it generates a risk assessment evaluation value 450, in which the risk assessment evaluation value 450 can be expressed mathematically by the following equation:

RAPID=CONFIDENCE×COVERAGE×CRITERIA

wherein the RAPID (Risk Assessment for Process Improvement Decision) represents the risk assessment evaluation value 450, CONFIDENCE the confidence value 412, COVERAGE the coverage value 422 and CRITERIA the criteria value 432, and greater risk assessment evaluation value 450 is considered to be of higher risk, similarly, smaller risk assessment evaluation value 450 is deemed be of lower risk.

The execution of step S208 determines whether the risk assessment evaluation value 450 exceeds a predetermined risk value or not; if not, then skip the next step S210 and go directly to the final step S212 of transferring the semiconductor process change to assembly line process; otherwise, if yes, then perform the next step S210, in which the predetermined risk value may be determined either manually by a user, or else automatically by the computer.

The execution of step S210 performs an active inspection for the corresponding values of the plurality of items against their respective predetermined item setting values, in order to determine if the predetermined item setting values has been exceeded or not; in other words, the active inspection respectively checks whether the corresponding values of the plurality of items concerning the semiconductor process change exceeds a corresponding item setting value; in case yes, then repeat the above-mentioned steps; if the item setting value has not been exceeded, then go to next step and final step of S212. However please keep in mind that the item setting value may be determined either manually by a user, or automatically by a computer.

The execution of step S212 transfers the semiconductor process change to an assembly line process (ECN: with Engineering Change Note), directly proceeding normal process mass-production.

Refer now to FIG. 4, wherein a table 400 is drawn based on different calculation results for determining the semiconductor process change. In the present embodiment, the predetermined risk value is manually set by users to be 1, the item setting value is manually set by users to be 3, it then determines whether the risk assessment evaluation value 450 in the table 400 has exceeded the predetermined risk value; in case not exceeding 1, then it directly transfers he semiconductor process change to an assembly line process; if yes (i.e. exceeding 1), then it further determines whether any of the confidence value 412, the coverage value 422 and the criteria value 432 in the table 400 has exceeded the corresponding item setting value or not. In case it is determined it has exceeded 3, then the semiconductor process changed will directly be regarded as INVALID RISK ASSESSMENT, OVER CRITERIA, then repeat the above-mentioned steps; if not (i.e. determined to be within 3), then based on the result of the risk assessment evaluation value 450 it first transfers the semiconductor process change with lower risk into median-quantity experimental non-batch (TECN: with Temporary Engineering Change Note), then next into the assembly line process. Additionally, it transfers the semiconductor process change with higher risk into small-quantity experimental batch (SPL: Sample Product Line), then finally into the assembly line process.

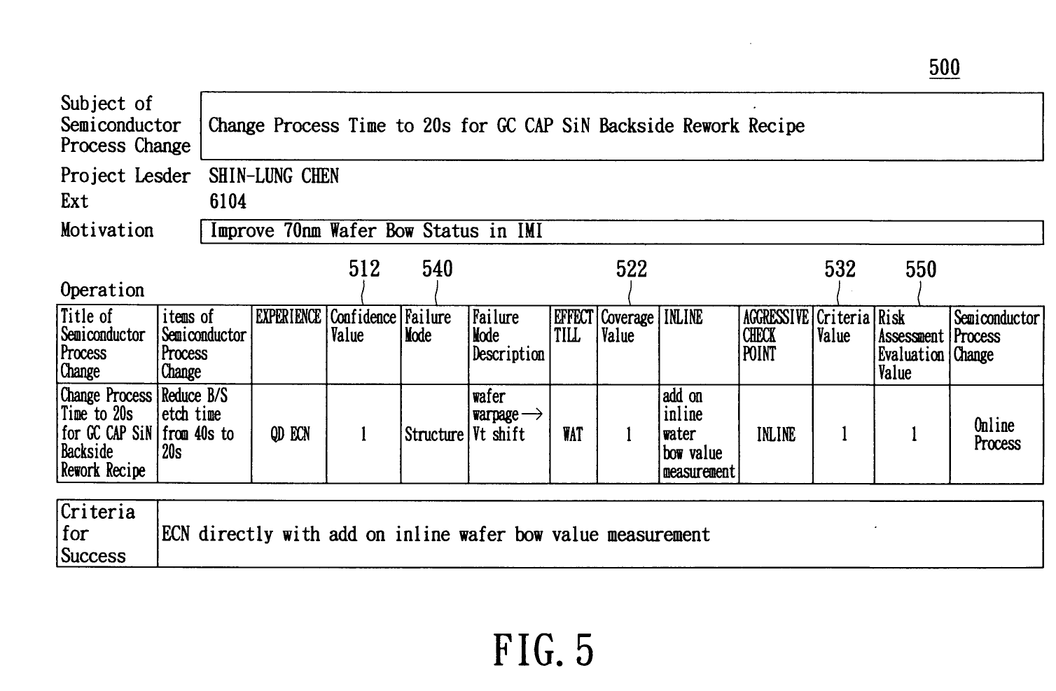

Refer now to FIG. 5, wherein a user proposes a risk assessment evaluation table 500 in terms of a subject of semiconductor process change for a project leader, in which the risk assessment evaluation table 500 provides the results of risk assessment for the subject of semiconductor process change, and the risk assessment evaluation table 500 comprises motivation, subject of semiconductor process change and items concerning the semiconductor process change, then the aforementioned assessment method step S200 for process improvement decisions is performed. In the present embodiment, multiplication of the confidence value 512, the coverage value 522 and the criteria value 532 generates a risk assessment evaluation value 550, in which the failure mode 540 is STRUCTURE, and the value 1 of the risk assessment evaluation value 550 belongs to low risk, accordingly the semiconductor process change will be transferred into assembly line process.

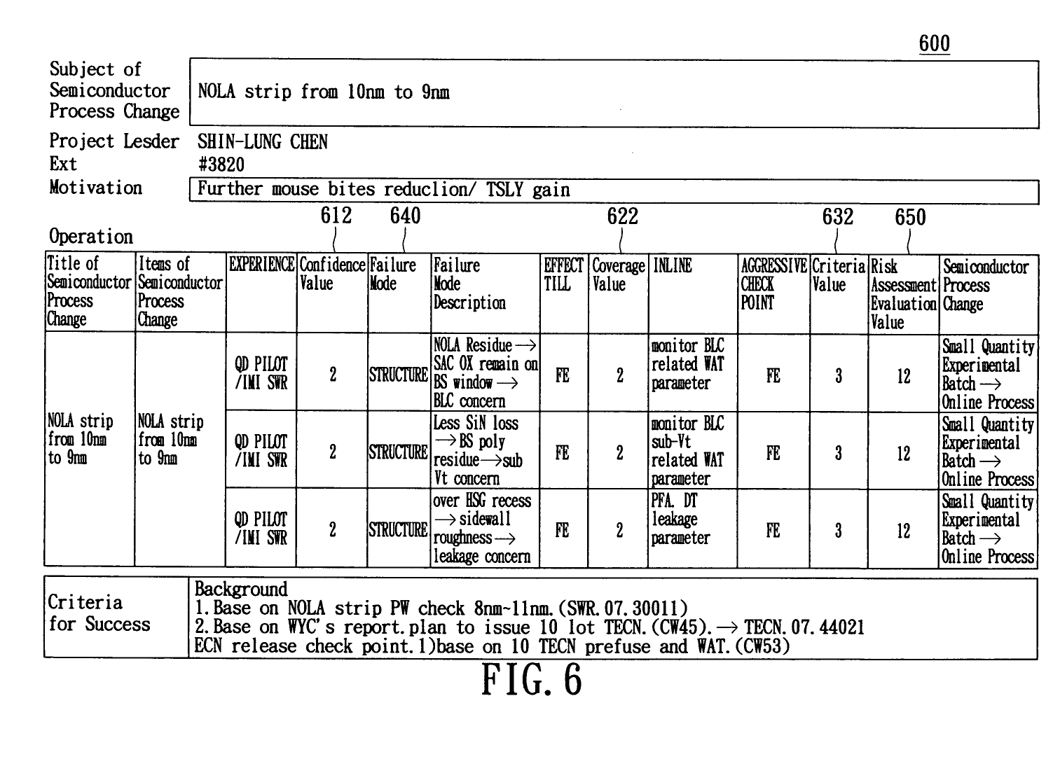

Refer now to FIG. 6, wherein a user proposes a risk assessment evaluation table 600 in terms of another subject of semiconductor process change for a project leader, in which the risk assessment evaluation table 600 provides the results of risk assessment for the subject of semiconductor process change. In the present embodiment, multiplication of the confidence value 612, the coverage value 622 and the criteria value 632 generates a risk assessment evaluation value 650, in which the failure mode 640 is STRUCTURE and DEFECTIVITY, and the value 12 of the risk assessment evaluation value 650 falls in the range of high risk, accordingly the semiconductor process change will be first transferred into SPL/TECN (Sample Product Line/Temporary Engineering Change Note), afterward into assembly line process.

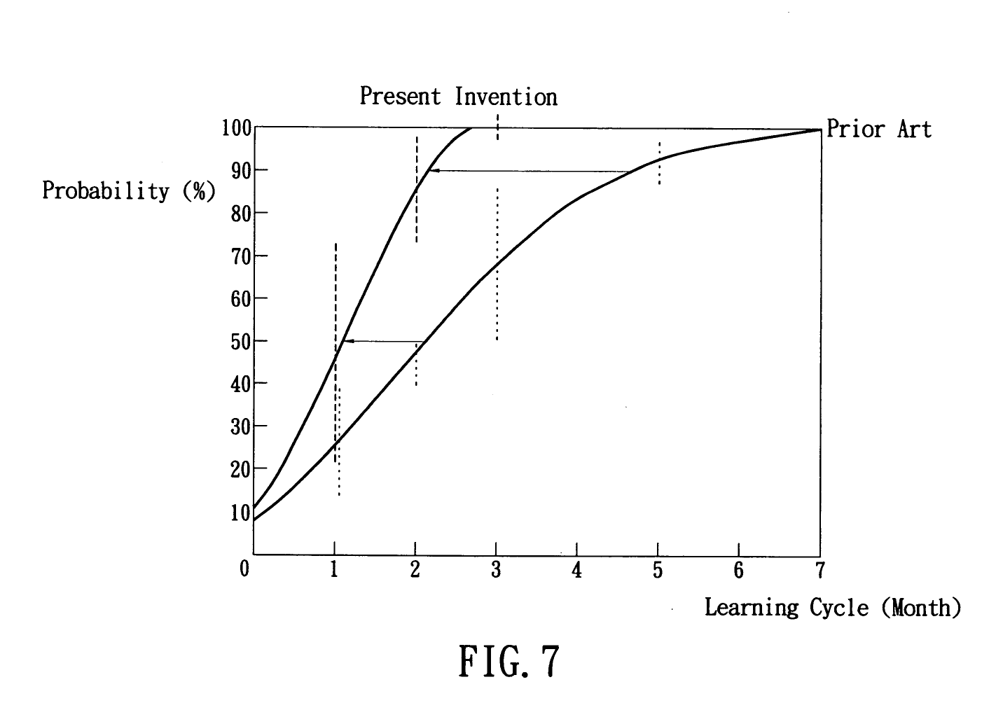

Refer now to FIG. 7, wherein the Y-axis represents the percentage of success probability of the semiconductor process change (%), the X-axis represents the learning cycle of the semiconductor process change (Month), and the said two items are presented in a linearly proportional relation. In the present embodiment, the percentage of success probability is 50, and compared with prior art, the learning cycle according to the present invention is lessened by approximately half, and under the condition that the percentage of success probability is 90, the learning cycle according to the present invention may be reduced about 80%.

Compared with the prior art, the application of the present invention may present the following effects: (1) the risk assessment evaluation value provides determination on risk assessment and process improvement decision, creation of risk management of semiconductor process equipments and amelioration mechanism for reliability enhancement, thus achieving the objective of precaution in advance; (2) the EXPERIENCE provides determination of confidence value, effectively accumulation of historic experience, improving accordingly the process efficiency of semiconductor process change; (3) the INFLUENCE AREA offers determination of coverage value, effectively evaluating the influence range of failure, so as to reduce the coverage of influence caused by possible occurrence of failure, thus achieving the possibility for determining risk assessment and process improvement decision in the course of semiconductor process change; (4) the AGGRESSIVE CHECK POINT provides determination of criteria value, which offers the feature of precision for determining risk assessment and process improvement decision in the course of semiconductor process change; (5) the learning cycle for the semiconductor process change may be reduced.

Although the present invention has been disclosed by means of preferred embodiments set out supra, the above-stated descriptions are not at all intended to limit the scope of present invention thereto; any skilled ones in relevant arts may perform various modifications, alternations or substitutions without departing from the spirit and scope of the present invention. Hence, the scope of the present invention required to be legally protected should be only delineated by the following claims.

What is claimed is:

1. An assessment method for process improvement decisions which is applicable to a semiconductor process change, comprising the following steps:
performing a risk assessment evaluation computation for a plurality of items each with a corresponding value, wherein the product of the corresponding value is for generating a risk assessment evaluation value;
comparing and determining whether the risk assessment evaluation value has exceeded a predetermined risk value or not, if not, then go to the final step of transferring the semiconductor process change to assembly line process;
if yes, then performing an active inspection for the corresponding values of the plurality of items against their respective predetermined item setting values, in order to determine if the predetermined item setting values has been exceeded or not;
next, if the predetermined item setting values has been exceeded, repeat the above step of risk assessment evaluation value comparison; otherwise
if the predetermined item setting values has not been exceeded, then go to the final step of transferring the semiconductor process change to online process.

2. The assessment method for process improvement decisions according to claim 1, wherein the said plurality of items consist of at least an EXPERIENCE, an INFLUENCE AREA and an AGGRESSIVE CHECK POINT.

3. The assessment method for process improvement decisions according to claim 2, wherein the said EXPERIENCE includes:
QD ECN (Quality Design with Engineering Change Note: there exist other factories of the same category);
QD PILOT/IMI SWR (Quality Design Pilot/Incoming Material Inspection of Semiconductor Wafer Representation: batch experiment in median/small quantity during experiment);
SUPPORTING ANALYSIS; or
NO EXPERIENCE.

4. The assessment method for process improvement decisions according to claim 3, wherein the value to which the EXPERIENCE corresponds is a confidence value, and which confidence value is sequentially 1, 2, 3 and 4.

5. The assessment method for process improvement decisions according to claim 2, wherein the INFLUENCE AREA includes WAT (Wafer Acceptance Test: electronic analysis), FE (front-end), BE (back-end) or RELIABILITY.

6. The assessment method for process improvement decisions according to claim 5, wherein the value to which the INFLUENCE AREA corresponds is a coverage value, and which coverage value is sequentially 1, 2, 3 and 4.

7. The assessment method for process improvement decisions according to claim 2, wherein the Aggressive Check Point consists of INLINE INSPECTION (assembly line check), WAT (Wafer Acceptance Test: electronic analysis), FE (front-end) or BE/ELT (back-end/essential laboratory test: client side).

8. The assessment method for process improvement decisions according to claim 7, wherein the value to which the Aggressive Check Point corresponds is a criteria value, and which criteria value is sequentially 1, 2, 3 and 4.

9. The assessment method for process improvement decisions according to claim 1, wherein the said predetermined risk value and item setting value can be determined either manually by a user, or else automatically set by a computer.

10. An assessment method for process improvement decisions which is applicable to a semiconductor process change, comprising the following steps:
classifying the plurality of items concerning the semiconductor process change;
performing a risk assessment evaluation computation for a plurality of items each with a corresponding value;
generating a risk assessment evaluation value, wherein the risk assessment evaluation value is the product of the corresponding values;
comparing and determining whether the risk assessment evaluation value has exceeded a predetermined risk value or not, if not, then go to the final step of transferring the semiconductor process change to assembly line process;
if yes, then performing an active inspection for the corresponding values of the plurality of items against their respective predetermined item setting values, in order to determine if the predetermined item setting values has been exceeded or not;
next, if the predetermined item setting values has been exceeded, repeat the above step of risk assessment evaluation value comparison;
otherwise if the predetermined item setting values has not been exceeded, then go to the final step of transferring the semiconductor process change to online process.

11. The assessment method for process improvement decisions according to claim 10, wherein the said plurality of items consist of at least an EXPERIENCE, an INFLUENCE AREA and an AGGRESSIVE CHECK POINT.

12. The assessment method for process improvement decisions according to claim 11, wherein the said EXPERIENCE includes:
QD ECN (Quality Design with Engineering Change Note: there exist other factories of the same category);
QD PILOT/IMI SWR (Quality Design PILOT/Incoming Material Inspection of Semiconductor Wafer Representation: batch experiment in median/small quantity during experiment);
SUPPORTING ANALYSIS; or
NO EXPERIENCE.

13. The assessment method for process improvement decisions according to claim 12, wherein the value to which the EXPERIENCE corresponds is a confidence value, and which confidence value is sequentially 1, 2, 3 and 4.

14. The assessment method for process improvement decisions according to claim 11, wherein the INFLUENCE AREA includes WAT (Wafer Acceptance Test: electronic analysis), FE (front-end), BE (back-end) or RELIABILITY.

15. The assessment method for process improvement decisions according to claim 14, wherein the value to which the INFLUENCE AREA corresponds is a coverage value, and which coverage value is sequentially 1, 2, 3 and 4.

16. The assessment method for process improvement decisions according to claim 11, wherein the Aggressive Check Point consists of INLINE INSPECTION (assembly line check), WAT (Wafer Acceptance Test: electronic analysis), FE (front-end) or BE/ELT (back-end/essential laboratory test: client side).

17. The assessment method for process improvement decisions according to claim 16, wherein the value to which the Aggressive Check Point corresponds is a criteria value, and which criteria value is sequentially 1, 2, 3 and 4.

18. The assessment method for process improvement decisions according to claim 10, wherein the said predetermined risk value and item setting value can be determined either manually by a user, or else automatically set by a computer.
